(19) United States
(12) Patent Application Publication
(10) Pub. No.: US 2010/0054791 A1
(43) Pub. Date: Mar. 4, 2010

(54) Image forming apparatus

(75) Inventor: Keisuke Shimizu, Tokyo (JP)

Correspondence Address: HARNESS, DICKEY & PIERCE, P.L.C., P.O. BOX 8910, RESTON, VA, 20195, US

(73) Assignee: RICOH COMPANY, LTD.

(21) Appl. No.: 12/461,731

(22) Filed: Aug. 21, 2009

(30) Foreign Application Priority Data
Aug. 26, 2008 (JP) 2008-216571

(51) Int. Cl. G03G 21/20

(52) U.S. Cl. 399/92

(57) ABSTRACT

An image forming apparatus comprising a fixing unit; a discharge unit; a stacking unit; an inversion guide; a cooling fan; an opening; a duct; and a second duct, wherein the discharge unit is provided on a downstream side of the side end of the fixing unit in a paper discharge direction, and an air flow direction from the duct toward the second duct is substantially matched with a direction in which hot air above the fixing unit is taken in by the cooling fan.

### BACKGROUND OF THE INVENTION

1. Field of the Invention

The present invention relates to an image forming apparatus such as a copying machine, a printer, and a facsimile.

2. Discussion of the Related Art

FIG. 1 illustrates a printer 1 that is an example of a conventional image forming apparatus in which an electrophotographic system is used. An optical device 20 irradiates an image forming device 10 with light, the image forming device 10 forms a toner image, and a transfer device 30 conveys and transfers the toner image to a sheet material P. On the other hand, a paper feed roller 41 picks up the sheet material P stacked on a sheet material supplying device 40, the sheet material P is conveyed from a registration roller 42 to a transfer device 30, and the toner image is transferred to the sheet material P. Then a fixing device 50 heats and fixes the toner image to the sheet material P, the sheet material P is conveyed to a sheet material discharge roller 60, and the sheet material P is stacked on a sheet material stacking unit 70.

Because the fixing device 50 heats and fixes the toner image, the inside of the fixing device 50 becomes extremely high temperatures. Therefore, heat is transmitted from the fixing device 50 to a periphery of the fixing device, particularly in the transfer device 30 or a toner storage device 80, which causes a risk of melting toner.

The sheet material P on which the toner image is fixed by the fixing device 50 also becomes high temperatures, and the sheet material P emits the heat between the fixing device 50 and the sheet material discharge roller 60. The heat increases temperatures of electric components, such as a sensor 90, which are provided in a conveying path between the fixing device and the sheet material discharge roller 60. When the temperature of the electric component exceeds an allowable temperature, a trouble is possibly caused in the electric component. When the sheet material P is stacked at high temperature on the sheet material stacking unit 70 while insufficiently cooled, the toner in the sheet material P stacked on the sheet material stacking unit 70 is possibly melted to cause a trouble in that the sheet materials P adhere to each other.

Recently demands for downsizing of the machine and improvement of productivity rise in the market, and cooling of the fixing and the thermally-fixed sheet material become a large issue.

Therefore, various countermeasures against the issue have been proposed to cool the fixing and the thermally-fixed sheet material. For example, in an image forming apparatus disclosed in Japanese Patent Application Laid-Open No. 2003-307996, exhaust heat units are provided near the fixing unit and the discharge and stacking unit, and ventilation holes are respectively made between the fixing unit and the exhaust heat unit and between the discharge and stacking unit and the exhaust heat unit, thereby cooling the sheet material and the path between the fixing unit and the discharge and stacking unit.

In an image forming apparatus disclosed in Japanese Patent Application Laid-Open No. 2005-10767, a cooling fan is disposed opposite a discharge conveying path in order to generate a flow from an image forming unit side toward the discharge conveying path, and outlets are provided in the discharge conveying path opposite the cooling fan and a sidewall, thereby cooling the sheet material after the fixing.

In an image forming apparatus disclosed in Japanese Patent Application Laid-Open No. 2002-333814, a duct is provided in the cooling fan provided in the apparatus in order to guide air to a paper discharge unit, and the outlet of the duct is opened immediately after a sheet exit, which allows the sheet discharged from the paper discharge port to be directly cooled after the fixing.

In an image forming apparatus disclosed in Japanese Patent Application Laid-Open No. 2005-258318, an intake is provided along a recording material conveying path in an outer frame in an opposite direction to a heating unit that heats an image, an outlet and exhaust fan are provided in an outer frame on the heating side, and an intake fan is provided in an air flow path between the intake and the outlet, in a midpoint of the heating unit on the air flow path and the outlet, and in a central portion in a lengthwise direction of the heating unit. Therefore, the periphery of the fixing unit and the recording material after the fixing are cooled.

In the image forming apparatus disclosed in Japanese Patent Application Laid-Open No. 2003-307996, exhaust heat units is provided near fixing unit and discharge and stacking unit, a ventilation hole is made between the discharge and stacking unit and exhaust heat unit. When the sheet materials are gradually stacked on the discharge and stacking unit, the ventilation hole is gradually closed to stop wind flow. Even if the ventilation hole is not completely closed, the sheet materials stacked on the discharge and stacking unit become high temperature because of the sheet material heated and fixed by the fixing unit. Therefore, the heat of the sheet material is taken in the machine, and possibly a cooling effect is insufficiently exerted.

In the image forming apparatus disclosed in Japanese Patent Application Laid-Open No. 2005-10767, the cooling fan is provided in a region from the fixing unit to the outlet, and an air flow blows the sheet material after the fixing by the cooling fan, thereby cooling the sheet material. The cooling fan is disposed in the apparatus while facing a discharge conveying path, whereby the heat emitted from the fixing unit is blocked so as not be transmitted to the periphery of the fixing unit. However, because the cooling fan is disposed in the apparatus, a pressure loss is increased, and it is necessary to enlarge the fan in order to obtain a predetermined air volume, which possibly influence the machine size. Particularly, in the high-productivity machine, a lack of air volume is probably generated only by the cooling fan provided in the apparatus.

In the image forming apparatus disclosed in Japanese Patent Application Laid-Open No. 2002-333814, the duct is provided in the cooling fan provided in the apparatus in order to guide the air to the paper discharge unit, and the outlet of the duct is opened immediately after the sheet exist, so that the sheet discharged from a paper discharge port can directly be cooled. Therefore, the sheet after the fixing is sufficiently cooled. However, except for the sheet after the fixing, particularly the electric component located in the conveying path from the fixing unit to the paper discharge port or the periphery of the fixing unit is insufficiently cooled.

In the image forming apparatus disclosed in Japanese Patent Application Laid-Open No. 2005-258318, an air flow path is ensured along the conveying path, and the intake and the outlet are provided in the end portion, that is, in the outer frame of the apparatus, and the exhaust fan is provided in the outlet or the intake fan is provided in the air flowpath, thereby cooling the periphery of the fixing unit and the sheet material after the fixing. However, the air flow path is ensured along the conveying path, and the cooling fan is provided in the air flow path. Therefore, it is necessary to largely ensure the air flow path, which advantageously enlarge the machine.

### SUMMARY OF THE INVENTION

Accordingly, an object of the present invention is to provide an image forming apparatus having a configuration, in which the heat transmission from the fixing unit to the periphery is blocked without enlarging the machine and the sheet material is cooled after the fixing, so that the adhesion of the sheet material on the sheet material stacking unit and the trouble with the heat of the electric component in the sheet material conveying unit and the component near the fixing unit can be prevented.

A first aspect of the present invention relates to an image forming apparatus including: a fixing unit that heats and fixes a sheet in which an image is formed; a discharge unit that is provided above the fixing unit to discharge the sheet passing through the fixing unit; a stacking unit on which the sheet discharged from the discharge unit is stacked; an inversion guide that is provided above the fixing unit to inverse the sheet passing through the fixing unit; a cooling fan that is disposed while facing a guide surface of the inversion guide; an opening that is provided in the guide surface of the inversion guide to form a flow passage of the cooling fan; a duct that is formed between the stacking unit and the fixing unit to take in ambient air; and a second duct that is formed between a side end of the fixing unit and an uprising wall to guide air from the duct above the fixing unit, the uprising wall being an upstream end of the stacking unit, wherein the paper discharge unit is provided on a downstream side of the side end of the fixing unit in a paper discharge direction, and an air flow direction from the duct toward the second duct is substantially matched with a direction in which hot air above the fixing unit is taken in by the cooling fan.

In the image forming apparatus according to the first aspect of the present invention, a second aspect of the present invention relate to the image forming apparatus wherein the ventilation hole is disposed adjacent to the fixing unit.

In the image forming apparatus according to the first or second aspect of the present invention, a third aspect of the present invention relates to the image forming apparatus wherein the ventilation hole is disposed across the sheet material conveying unit from the cooling fan.

In the image forming apparatus as in any one of the first to third aspects of the present invention, a fourth aspect of the present invention relates to the image forming apparatus wherein the cooling fan is disposed in a position except for a neighborhood of an outlet through which a sheet material is discharged from the sheet material conveying unit to the sheet material stacking unit.

In the image forming apparatus according to the fourth aspect of the present invention, a fifth aspect of the present invention relates to the image forming apparatus wherein the cooling fan is disposed near an extended line of a line connecting the ventilation hole and sheet material conveying unit.

In the image forming apparatus as in any one of the first to fifth aspects of the present invention, a sixth aspect of the present invention relates to the image forming apparatus, comprising aduct that guides the ambient air from the ventilation hole to the sheet material conveying unit.

In the image forming apparatus according to the sixth aspect of the present invention, a seventh aspect of the present invention relates to the image forming apparatus wherein part of the duct is disposed between the fixing unit and the transfer unit.

In the image forming apparatus according to the sixth or seventh aspect of the present invention, an eighth aspect of the present invention relates to the image forming apparatus wherein a toner storage device is disposed across the duct from the fixing unit.

According to the invention, the ambient air introduced from the ventilation hole is guided to the cooling fan through the conveying path of the sheet material. Therefore, the sheet material is efficiently cooled after the fixing because of the direct exposure of the sheet material to the ambient air, and the conveying path of the sheet material is cooled by the ambient air, so that the sheet material can be cooled after the fixing while the heat from the fixing unit is blocked.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

FIG. 1 is a schematic sectional view illustrating a printer that is an example of a conventional image forming apparatus in which an electrophotographic system is used;

FIG. 2 is a sectional view illustrating a printer that is an example of an image forming apparatus according to a first embodiment of the invention;

FIG. 3 is a detailed view illustrating a periphery of a fixing device;

FIG. 4 is a perspective view illustrating the periphery of the fixing device;

FIG. 5 is a perspective view illustrating the periphery of the fixing device;

FIG. 6 illustrates a sectional layout in which a paper discharge roller is disposed on a front side of a back surface of the fixing device;

FIG. 7 illustrates temperature evaluation when a paper discharge tray is inclined in the layout of FIG. 6;

FIG. 8 is a detailed view illustrating a periphery of a fixing device according to a second embodiment of the invention; and

FIG. 9 is a detailed view illustrating a periphery of a fixing device according to a third embodiment of the invention.

### DESCRIPTION OF THE PREFERRED EMBODIMENTS

Generally, the present invention provides an image forming apparatus. Although a printer is described by way of example in the following embodiments, the invention is not limited to the printer, but the invention can be applied to various image forming apparatuses.

A first object of the invention is to provide an image forming apparatus having a configuration, in which the heat transmission from the fixing unit to the periphery is blocked without enlarging the machine and the sheet material is cooled after the fixing, so that the adhesion of the sheet material on the sheet material stacking unit and the trouble with the heat of the electric component in the sheet material conveying path and the component near the fixing unit can be prevented. The image forming apparatus includes a fixing unit 50 that heats and fixes a sheet in which an image is formed, a discharge unit 60 that is provided above the fixing unit 50 to discharge a sheet material P passing through the fixing unit 50, a stacking unit 70b on which the sheet material P discharged from the discharge unit 60 is stacked, an inversion guide 96 that is provided above the fixing unit 50 to inverse the sheet material P passing through the fixing unit 50, a cooling fan 93 that is disposed while facing a guide surface of the inversion guide 96, an opening 96a that is provided in the guide surface of the inversion guide 96 to form a flow passage of the cooling fan 93, a duct 92 that is formed between the stacking unit 70b and the fixing unit 50 to take in ambient air, and a region 70a of a paper discharge unit, the region 70a constituting a second duct that is formed between a side end of the fixing unit 50 and an uprising wall to guide air from the duct 92 above the fixing unit 50, the uprising wall being an upstream end of the stacking unit 70b. In the image forming apparatus, the discharge unit 60 is provided on a downstream side of the side end of the fixing unit 50 in a paper discharge direction, and an air flow direction from the duct 92 toward the second duct 70a is substantially matched with a direction in which hot air above the fixing unit 50 is taken in by the cooling fan 93. In the image forming apparatus, the ambient air introduced from the duct 92 is guided to the cooling fan 93 through a conveying path of the sheet material P. Therefore, the sheet material P is efficiently cooled after the fixing because of direct exposure of the sheet material to the ambient air, and the conveying path of the sheet material P is cooled by the ambient air, so that the sheet material P can be cooled after the fixing while the heat from the fixing unit 50 is blocked.

When the electric component easily affected by the heat or the device including the toner is disposed near the fixing unit 50, possibly the trouble such as the electric component failure and the adhesion of the toner in the device is generated by heat radiated from the fixing unit 50. Therefore, a second object of the invention is to provide an image forming apparatus has a configuration in which the electric component or the device including the toner, located near the fixing unit 50, can be prevented from generating the trouble caused by the heat radiated from the fixing unit 50. The image forming apparatus includes a transfer unit 30 that transfers an image formed by an image forming device 1 of the image forming unit to the sheet material P, the fixing unit 50 that heats and fixes the sheet material P in which the image is formed, the sheet material stacking unit 70b on which the sheet material P to which the image is fixed is stacked, and a conveying path of the sheet material through which the sheet material P is conveyed from the fixing unit 50 to the sheet material stacking unit 70b. In the image forming apparatus, the cooling fan 93 is disposed on the side opposite the sheet material stacking unit 70b while facing the conveying path of the sheet material P, and a ventilation hole 91a communicated with the outside of the apparatus is provided below the conveying path of the sheet material P. Because the ventilation hole 91a is disposed adjacent to the fixing unit 50, the ambient air introduced from the ventilation hole 91a flows through the neighborhood of the fixing unit 50. Therefore, the heat radiated from the fixing unit 50 can be blocked, and the electric component and the device including the toner, located near the fixing unit 50, can be prevented from generating the trouble caused by the heat radiated from the fixing unit 50.

A third object of the invention is to provide an image forming apparatus having a configuration in which the heat of the fixing unit 50 is efficiently blocked from the components provided in the periphery of the fixing unit 50. Therefore, the ventilation hole 91a is disposed adjacent to the fixing unit 50. Because the ventilation hole 91a is disposed on the side of the sheet material stacking unit 70b in relation to the conveying path of the sheet material P, the ventilation hole 91a is provided inside the fixing unit 50 in the image forming apparatus. Therefore, the heat of the fixing unit 50 can efficiently be blocked from the components provided in the periphery of the fixing unit 50 in the image forming apparatus, and the trouble caused by the heat radiated from the fixing unit can be prevented.

A fourth object of the invention is to provide an image forming apparatus in which the cooling fan 93 is properly disposed and the ambient air is introduced from the ventilation hole 91a so as to pass through the conveying path of the sheet material P. Unless the cooling fan 93 is properly disposed, the ambient air is introduced from the ventilation hole 91a, and possibly the air flow passing through the conveying path of the sheet material P is not generated. Accordingly, the sheet material P can efficiently be cooled after the fixing, and the heat radiated from the fixing unit 50 can efficiently be blocked.

Fifth and sixth objects of the invention are to be able to enhance efficiency of the cooling fan 93 to more efficiently perform the cooling. That is, the cooling fan 93 is disposed near an extended line of a line connecting the ventilation hole 91a and sheet material conveying unit, or the image forming apparatus includes a duct 92 that guides the ambient air from the ventilation hole 91a to the conveying path of the sheet material P. Therefore, the conveying path of the sheet material P is disposed on the straight line connecting the ventilation hole 91a and the cooling fan 93, and the linear flow is generated from the ventilation hole 91a to the cooling fan 93, thereby obtaining the flow having the low pressure loss and good efficiency. Accordingly, the efficiency of the cooling fan 93 is enhanced, so that the sheet material P can effectively be cooled after the fixing and the heat radiated from the fixing unit can be blocked. The pressure loss from the ventilation hole 91a to the conveying path of the sheet material P is decreased by providing the duct 92 that guides the ambient air from the ventilation hole 91a to the conveying path of the sheet material P, and the air volume generated by the cooling fan 93 is increased, so that the sheet material P can effectively be cooled after the fixing and the heat radiated from the fixing unit can be blocked.

A seventh object of the invention is to provide an image forming apparatus having a configuration in which the heat radiated from the fixing unit can efficiently be blocked to prevent the trouble with the heat of the components near the fixing unit. Therefore, part of the duct 92 is disposed between the fixing unit 50 and the transfer unit 30 to block the heat radiated from the fixing unit 50 such that the heat is not transmitted to the transfer unit 30.

An eighth object of the invention is to be able to prevent the adhesion of the toner in the toner storage device 80 provided near the fixing unit 50. The adhesion of the toner in the toner storage device 80 is generated by the heat radiated from the fixing unit 50. Therefore, the toner storage device 80 is disposed across the duct 92 from the fixing unit 50, so that the heat radiated from the fixing unit 50 can be blocked by the ambient air flowing in the duct 92 to prevent the adhesion of the toner in the toner storage device 80, caused by the heat radiated from the fixing unit 50.

### First Embodiment

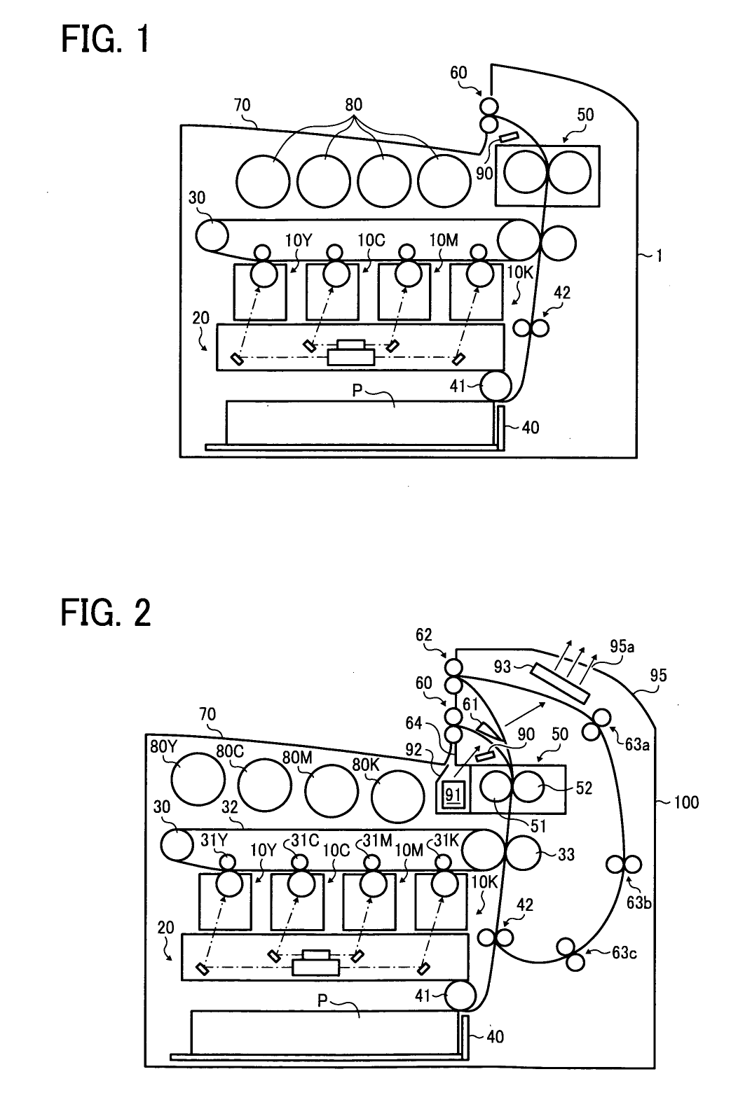

FIG. 2 is a sectional view illustrating a printer 100 that is an example of the image forming apparatus according to a first embodiment of the invention. In FIG. 2, the configuration in common with that of FIG. 1 is designated by the same numeral.

Referring to FIG. 2, the printer 100 includes four color image forming devices 10Y (yellow), 10C (cyan), 10M (magenta), and 10K (black), an optical device 20 that is of exposure unit for being able to irradiate the image forming devices with a laser beam, the transfer device 30 that conveys and transfers a toner image, the sheet material supplying device 40, and the fixing device 50. A paper feed roller 41 picks up the sheet material P stored in the sheet material supplying device 40, a registration roller 42 conveys the sheet material P to the transfer device 30 while adjusting conveying timing of the sheet material P. On the other hand, the optical device 20 irradiates the image forming devices 10Y, 10C, 10M, and 10K with the light to form toner images, and primary transfer rollers 31K, 31M, 31C, and 31Y perform primary transfer of the toner images to a transfer belt 32. A secondary transfer roller 33 performs secondary transfers of the toner images on the transfer belt 32 to the sheet material P. The sheet material P to which the toner images are transferred is thermally fixed by a heating roller 51 and a pressurizing roller 52 in the fixing device 50.

After the fixing, the sheet material P is guided to a paper discharge roller 60 by a branch pawl 61, and P is discharged to a paper discharge tray 70. In the case of both-sided printing, the branch pawl 61 is turned by a solenoid (not illustrated), the sheet material P to which the toner images are fixed by the fixing device 50 is guided to an inversion roller 62, the inversion roller 62 is reversely driven to guide the sheet material P to double-sided rollers 63a, 63b, and 63c, and the toner images are transferred from the registration roller 42 to a second surface of the sheet material P. Then the sheet material P to which the toner images are fixed by the fixing device 50 is guided to the paper discharge roller 60 by the branch pawl 61, and the sheet material P is discharged to the paper discharge tray 70. The toner storage devices 80K, 80M, 80C, and 80Y are disposed in the same order as the image forming devices 10K, 10M, 10C, and 10Y, and the toner is supplied to the image forming device 10 as needed.

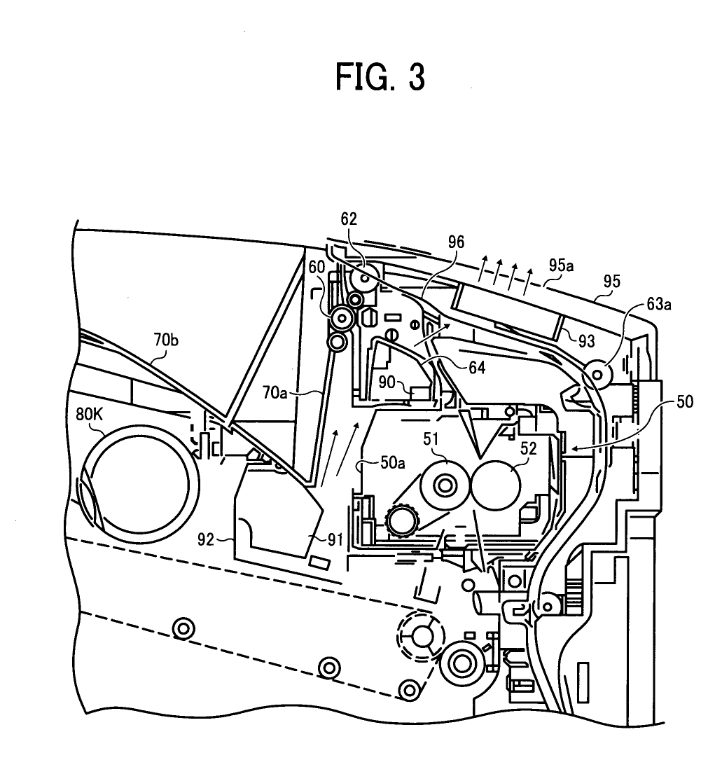

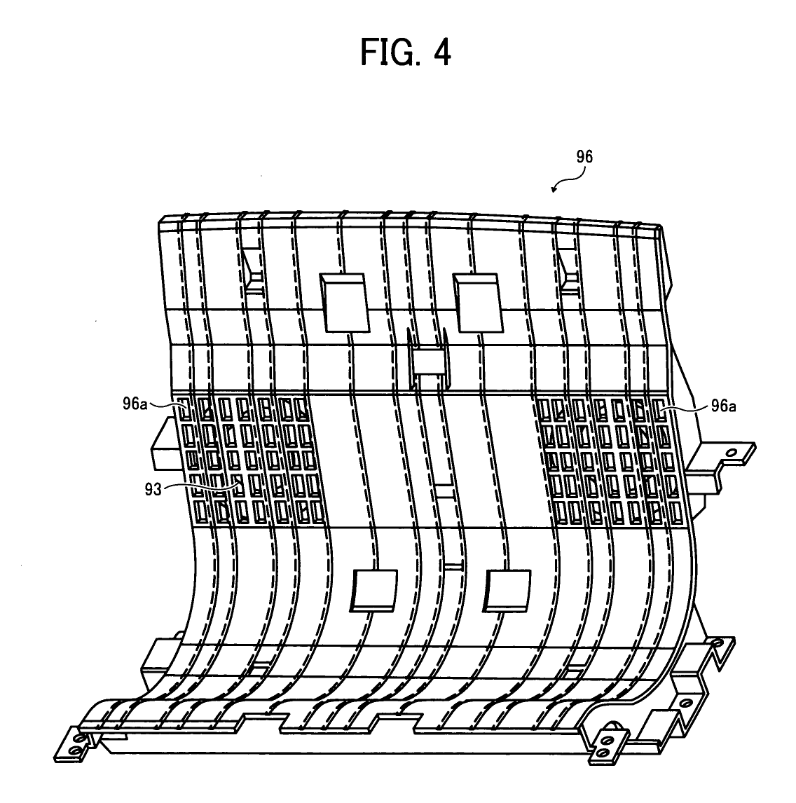

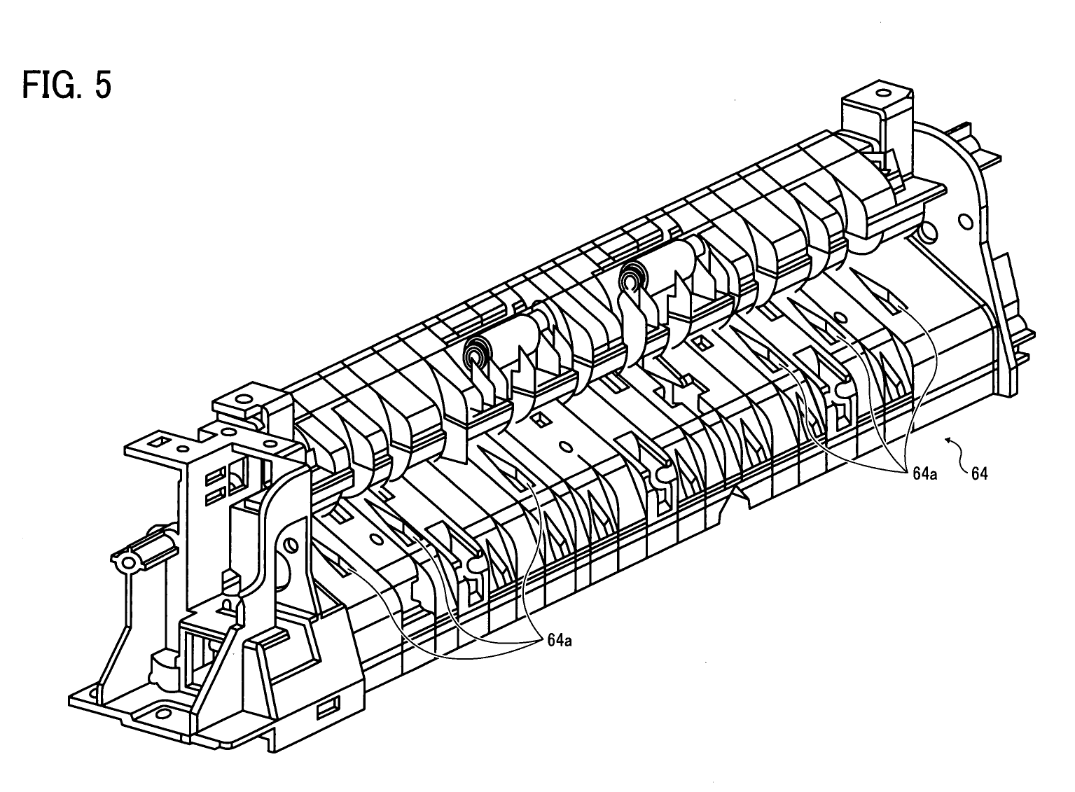

A periphery of the fixing device 50 of the first embodiment will be described in detail with reference to FIGS. 3, 4, and 5. FIG. 3 is a detailed view illustrating the periphery of the fixing device 50, and FIGS. 4 and 5 a perspective view illustrating the periphery of the fixing device 50. In FIGS. 3, 4, and 5, the configuration in common with that of FIG. 2 is designated by the same numeral, and the description is not given.

As illustrated in FIG. 3, an intake 91 is provided at the back of the fixing device 50, and the duct 92 is provided so as to surround the intake 91. On the other hand, the cooling fan 93 is provided between the inversion roller 62 and the double-sided roller 63a while facing the paper discharge guide 64. As shown in FIGS. 4 and 5, the cooling fan 93 is retained by a double-sided guide 96, and a slit 96a that is of the ventilation hole is provided in the position of the cooling fan 93. Similarly plural slits 64a that are of the ventilation hole are provided in the paper discharge guide 64 of FIG. 5.

The ambient air taken in from intake 91 by the cooling fan 93 passes through intervals between a back surface 50a of the fixing device and the duct 92 and between the back surface 50a of the fixing device and a paper discharge tray 70a to cool a paper discharge sensor 90 provided in the paper discharge guide 64, the ambient air passes through the slit 64a of the paper discharge guide and the slit 96a of the double-sided guide, and the ambient air is exhausted from a slit 95a provided in a cover 95. The ambient air directly blows the image surface side of the sheet material P that becomes high temperature by the thermal fixing of the fixing device 50, thereby efficiently cooling the sheet material P. The ambient air also directly blows the paper discharge sensor 90 in the paper discharge guide 63, so that the paper discharge sensor 90 can be prevented from exceeding the allowable temperature. The ventilation hole 91 and the duct 92 are disposed between the fixing device 50 and the toner storage device 80K, so that the heat radiated from the fixing device 50 can be blocked to prevent the toner adhesion caused by the heat of the fixing in the toner storage device 80K. Arrows illustrated in FIGS. 2 and 3 indicate the air flow generated by the cooling fan 93.

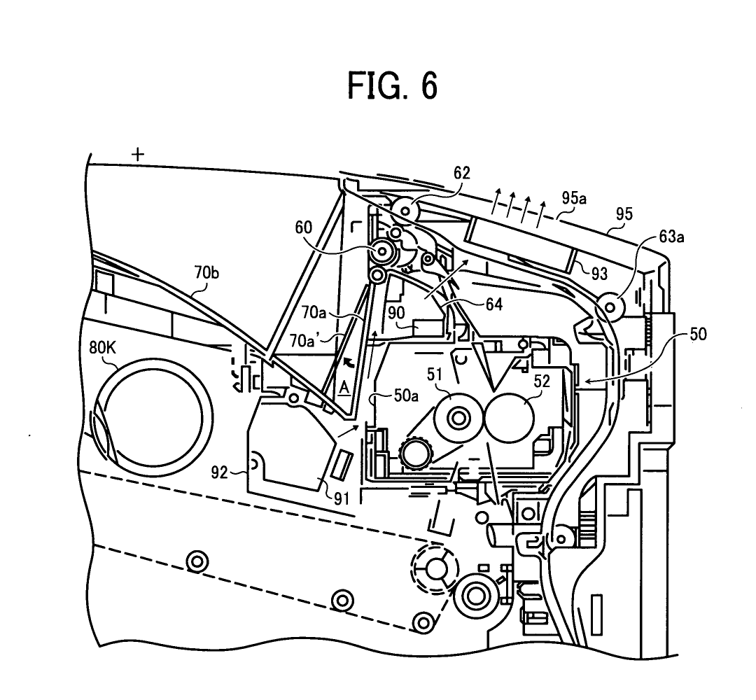

In the first embodiment, as illustrated in FIG. 3, the paper discharge roller 60 is disposed at the back of the fixing device back surface 50 to sufficiently ensure a clearance between the paper discharge tray 70a and the fixing device back surface 50a, so that the increase in pressure loss of the cooling fan can be prevented to ensure the air volume enough to cool the sheet material P. FIG. 6 illustrates a sectional layout in which the paper discharge roller 60 is disposed on a front side of the back surface 50a of the fixing device 50. As illustrated in FIG. 6, a clearance surrounded by a portion A between the paper discharge tray 70a and the fixing device back surface 50a is narrower than that of FIG. 3. Therefore, the pressure loss of the cooling fan is increased, and possibly the air volume enough to cool the sheet material P cannot be ensured.

The clearance can be enlarged when a paper discharge tray 70a′ inclined in the direction of FIG. 6 is used instead of the paper discharge tray 70a. However, in the case of the paper discharge tray 70a′, because the paper discharge tray 70a′ has a large inclination angle with respect to a vertical direction, the sheet material is easily caught by the paper discharge tray 70a′ immediately after the paper discharge, and possibly the number of sheet materials that can be stacked on the paper discharge tray 70 is decreased. That is, when the paper discharge roller 60 is disposed in front of the fixing device back surface 50a, it is necessary that the paper discharge tray 70a be disposed at an angle close to perpendicularity to the paper discharge roller in order to ensure a paper discharge stacking property. As a result, the clearance between the paper discharge tray 70a and the fixing device back surface 50a becomes narrowed, and possibly a lack of cooling is generated. In the first embodiment, as illustrated in FIG. 3, the paper discharge roller 60 is disposed at the back of the fixing device back surface 50a, so that a balance between the paper discharge stacking property and the sheet material cooling can be established. Thus, a positional relationship between the fixing device back surface 50a and the paper discharge roller 60 is required.

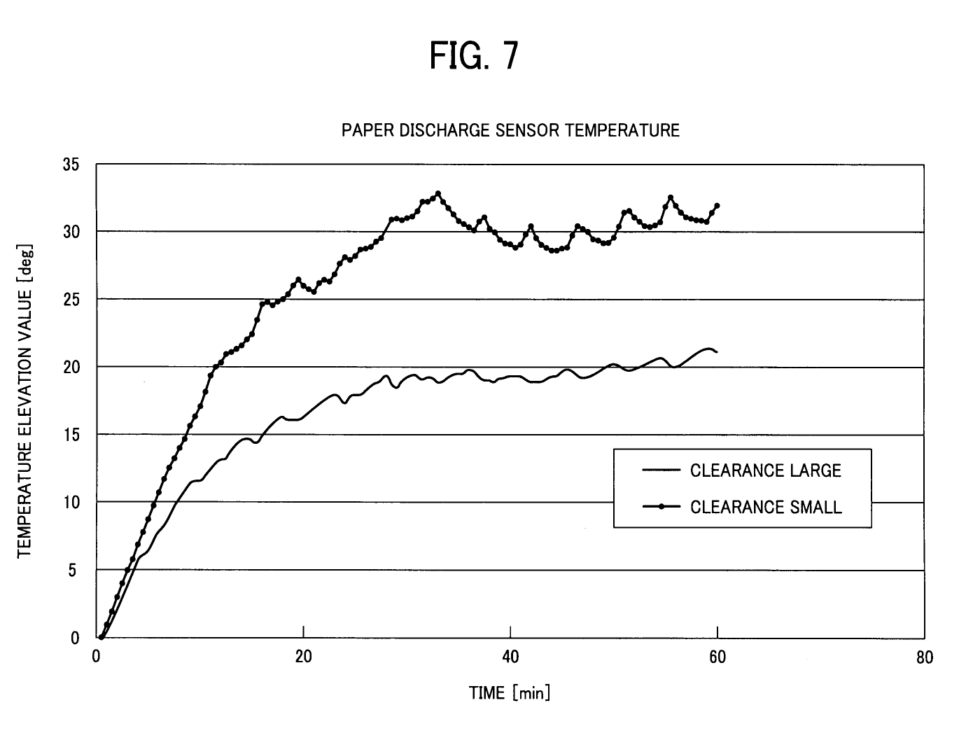

Then, in a layout of FIG. 6, temperature evaluation is performed using the paper discharge tray 70a and the paper discharge tray 70a′ in which the paper discharge tray 70a is inclined, and an influence of the clearance between the paper discharge tray 70a and the fixing device 50a on temperature is checked. FIG. 7 illustrates temperature history result. FIG. 7 illustrates temperature result of the paper discharge sensor 90 in color double-sided continuous printing. In FIG. 7, a horizontal axis indicates time (minute) and a vertical axis indicates a temperature elevation value from the beginning. As can be seen from FIG. 7, with increasing clearance, a temperature at the paper discharge sensor 90 is lowered by 10° C. or more. The gap between the paper discharge tray 70a and the fixing device back surface 50a is necessary in the cooling configuration of the first embodiment. Desirably the clearance is equal to or larger than 5 mm.

### Second Embodiment

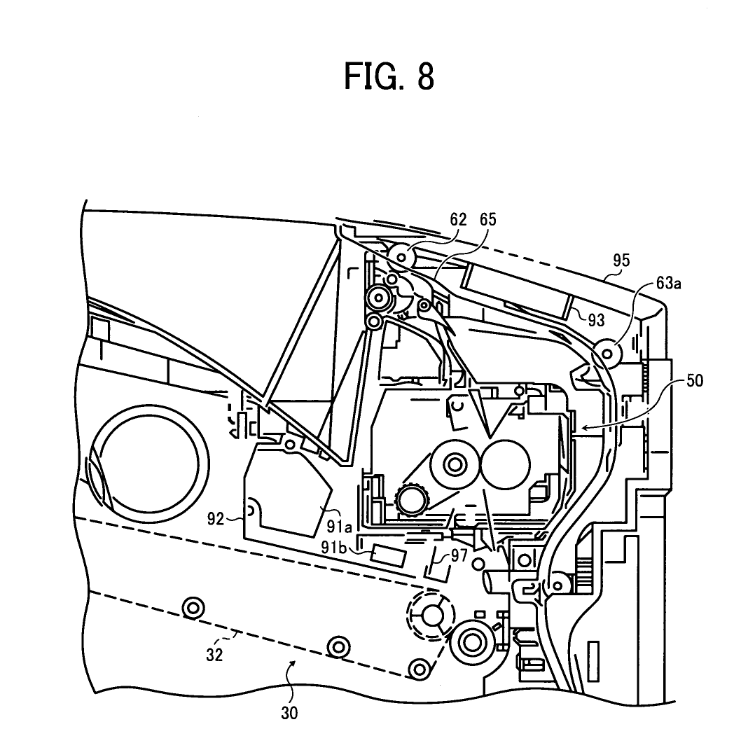

A second embodiment of the invention will be described with reference to FIG. 8. FIG. 8 is a detailed view illustrating a periphery of a fixing device 50 according to a second embodiment of the invention. A basic configuration of the second embodiment is identical to that of the first embodiment. In FIG. 8, the configuration in common with that of the first embodiment is designated by the same numeral, and the description is not given.

Ventilation holes 91a and 91b are made on the left side and lower side of the fixing device 50. Thus, the plural ventilation holes 91 may be provided. The duct 92 is disposed so as to surround the ventilation holes 91, and part of the duct 92 is provided between the fixing device 50 and the transfer device 30. A TM sensor 97 is provided between the duct 92 and the transfer device 30. The TM sensor 97 measures a toner density and a position on the transfer belt 32. The TM sensor 97 senses the toner density and position on the transfer belt 32 at intervals of the number of printing sheet, and the sensing result is fed back to form the image. Therefore, a fluctuation in density or position of the image or color shift can be prevented.

As illustrated in FIG. 8, because the TM sensor 97 is disposed between the fixing device 50 and the transfer device 30, the temperature of the TM sensor 97 is increased by the heat from the fixing device 50, and a risk of lowering the sensor function is generated when the temperature of the TM sensor 97 exceeds the allowable temperature. However, in the second embodiment, because the duct 92 is disposed between the TM sensor 97 and the fixing device 50, the TM sensor 97 is blocked from the heat radiated from the fixing device 50, and the TM sensor 97 and the transfer device 30 are not influenced by the fixing device. Therefore, the trouble caused by the heat radiated from the fixing device can be prevented.

### Third Embodiment

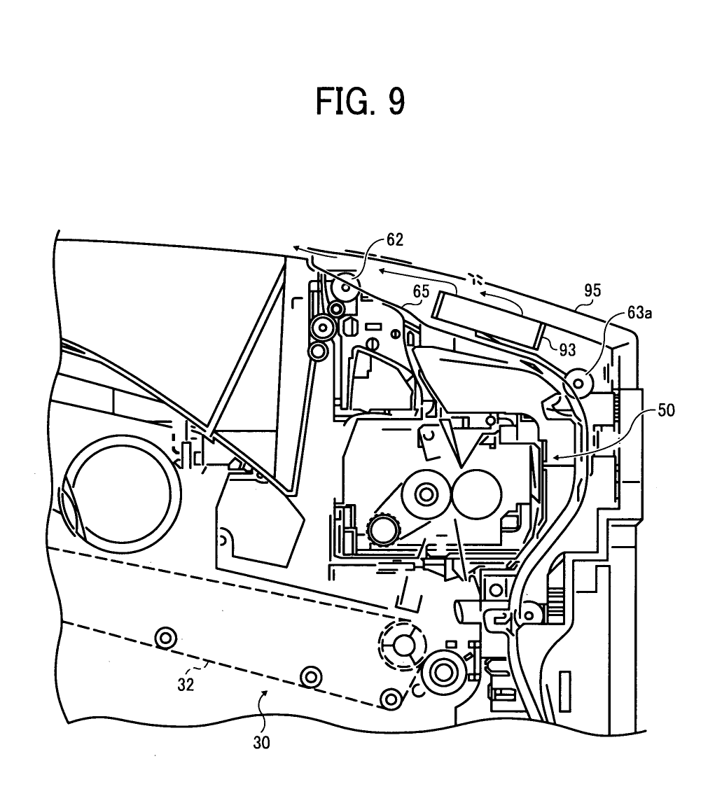

A third embodiment of the invention will be described with reference to FIG. 9. FIG. 9 is a detailed view illustrating a periphery of a fixing device 50 according to a third embodiment of the invention. A basic configuration of the third embodiment is identical to that of the first embodiment. In FIG. 9, the configuration in common with that of the first embodiment is designated by the same numeral, and the description is not given.

The cooling fan 93 is attached to an inversion guide 65 that guides the conveyance of the sheet material P from the inversion roller 62 to the double-sided roller 63a. The flow of the air exhausted from the cooling fan 93 passes through a duct forming portion formed by the inversion guide 65 and the cover 95 and the air is exhausted in the same direction as the discharge direction of the sheet material P. In the configuration of the first embodiment, in the printer, the exhaust direction of the cooling fan 93 becomes the direction of the front surface of the image forming apparatus 100, and the exhaust air directly blows a user. On the other hand, in the configuration of FIG. 9, because the sir is exhausted in the same direction as the discharge direction of the sheet material P, the exhaust air does not blow the user.

Additional modifications and variations of the present invention are possible in light of the above teachings. It is therefore to be understood that within the scope of the appended claims the invention may be practiced other than as specifically described herein.

What is claimed is:

1. An image forming apparatus comprising:
a fixing unit that heats and fixes a sheet in which an image is formed;
a discharge unit that is provided above the fixing unit to discharge the sheet passing through the fixing unit;
a stacking unit on which the sheet discharged from the discharge unit is stacked;
an inversion guide that is provided above the fixing unit to inverse the sheet passing through the fixing unit;
a cooling fan that is disposed while facing a guide surface of the inversion guide;
an opening that is provided in the guide surface of the inversion guide to form a flow passage of the cooling fan;
a duct that is formed between the stacking unit and the fixing unit to take in ambient air; and
a second duct that is formed between a side end of the fixing unit and an uprising wall to guide air from the duct above the fixing unit, the uprising wall being an upstream end of the stacking unit,
wherein the discharge unit is provided on a downstream side of the side end of the fixing unit in a paper discharge direction, and
an air flow direction from the duct toward the second duct is substantially matched with a direction in which hot air above the fixing unit is taken in by the cooling fan.

2. The image forming apparatus according to claim 1, wherein the ventilation hole is disposed adjacent to the fixing unit.

3. The image forming apparatus according to claim 1, wherein the ventilation hole is disposed across the sheet material conveying unit from the cooling fan.

4. The image forming apparatus according to claim 1, wherein the cooling fan is disposed in a position except for a neighborhood of an outlet through which a sheet material is discharged from the sheet material conveying unit to the sheet material stacking unit.

5. The image forming apparatus according to claim 4, wherein the cooling fan is disposed near an extended line of a line connecting the ventilation hole and sheet material conveying unit.

6. The image forming apparatus according to claim 1, further comprising a duct that guides the ambient air from the ventilation hole to the sheet material conveying unit.

7. The image forming apparatus according to claim 6, wherein part of the duct is disposed between the fixing Unit and the transfer unit.

8. The image forming apparatus according to claim 6, wherein a toner storage device is disposed across the duct from the fixing unit.
